(19) United States
(12) Patent Application Publication
(10) Pub. No.: US 2026/0089602 A1
(43) Pub. Date: Mar. 26, 2026

(54) METHODS, APPARATUSES AND SYSTEMS FOR USER PLANE RECONFIGURATION DURING CONDITIONAL MOBILITY

(71) Applicant: Nokia Technologies Oy, Espoo (FI)

(72) Inventors: Behnam KHODAPANAH, Ismaning (DE); Umur KARABULUT, Munich (DE); Halit Murat GÜRSU, München (DE); Dariusz PALKA, Krakow (PL); Srinivasan SELVAGANAPATHY, Bangalore (IN); Ahmad AWADA, Munich (DE); Jedrzej STANCZAK, Wroclaw (PL)

(21) Appl. No.: 19/112,366

(22) PCT Filed: Sep. 20, 2023
(86) PCT No.: PCT/EP2023/075864

§ 371 Date: Mar. 17, 2025

(30) Foreign Application Priority Data
Sep. 29, 2022 (IN) 202241055941

(51) Int. Cl. H04W 36/36; H04W 36/00

(52) U.S. Cl. CPC H04W 36/362; H04W 36/0055

(57) ABSTRACT

A method for supporting a conditional mobility procedure involving a source network element serving a user equipment (UE) and at least one target network element, the method including obtaining a first delta radio resource control (RRC) configuration; storing the first delta RRC configuration; obtaining a second delta RRC configuration that is indicative of a difference between a RRC configuration of the source network element and an RRC configuration of the target network element; comparing the obtained second delta RRC configuration with the stored first delta RRC configuration to determine whether the first and second delta RRC configurations are identical or not; based on determining that the first and second delta RRC configurations are not identical: transmitting an RRC reconfiguration message to the UE; and based on determining that the first and second delta RRC configurations are identical: skipping the transmission of the RRC reconfiguration message to the UE.

### TECHNOLOGY

The present disclosure relates to conditional mobility, in particular to methods, apparatuses and systems for user plane reconfiguration during conditional mobility procedures, such as conditional handover (CHO), conditional PSCell change (CPC), conditional PSCell addition (CPA), or the like.

### BACKGROUND

Any discussion of the background art throughout the specification should in no way be considered as an admission that such art is widely known or forms part of common general knowledge in the field.

Broadly speaking, a conditional handover (CHO) procedure has been introduced in 3rd Generation Partnership Project (3GPP) Release 16 to improve the mobility robustness. In the case of CHO, the network may prepare multiple target cells where each conditional handover reconfiguration is associated with a CHO execution condition that would be evaluated by the user equipment (UE). The CHO execution condition may refer to a measurement ID associating a measurement object with a reporting configuration and may be configured by the source gNB. The reporting configuration may generally define the measurement event (e.g., A3 or A5) which may trigger the reporting of the configured measurements. The same measurement events may also be configured by the UE which would trigger the CHO execution upon the configured measurement configuration is met. Whenever a CHO execution condition is met, the corresponding target configuration is selected, and the handover is executed towards the selected target cell.

In Release 16, another procedure called conditional PSCell (primary secondary Cell, which may also be considered a spCell of a secondary cell group (SCG)) change (CPC) has also been specified, but mainly for intra-SN (secondary node) scenarios. Later, CPC has been extended in Release 17 for inter-SN scenarios where it generally has two flavors, namely: MN (master node)-initiated CPC and SN-initiated CPC.

Some further enhancements proposed for the mobility work item in Release 18 also mentioned the following objectives, including specifying mechanisms and procedures of NR-DC (new radio-dual connectivity) with selective activation of the cell groups (at least for secondary cell group (SCG)) via L3 enhancements; to allow subsequent cell group change after changing CG (cell group) without reconfiguration and re-initiation of CPC or CPA (conditional PSCell addition).

Generally speaking, in CHO or CPC/CPA, the target node can generate either a full or a delta radio resource control (RRC) configuration for the candidate target primary cell (PCell) or PSCell, respectively. In case of a full configuration, the UE shall execute the steps that are defined in the standards, including releasing/cleaning some of the currently dedicated radio configurations and all current common radio configurations and applying the default medium access control (MAC) cell group configuration and service radio bearer (SRB) configuration. On the other hand, in the case of a delta configuration, the configuration of the candidate target cell contains only the parameters that need to be modified compared to the configuration of the current source cell (that is subject to change). As such, the size of the delta configuration can be much smaller than that of the full configuration which would then reduce substantially the overhead over the radio interface.

When the user plane configuration of the UE is updated (e.g., new bearers are configured, QoS flows created for the RRC connection, or the like), the RRC reconfiguration (e.g., for the modified data radio bearer (DRB) configuration) would have to be provided to the UE. As an example, the delay in activating the bearer is the time it would take for this signaling procedure in normal scenarios. In the case of a classic handover, this reconfiguration needs to be triggered after handover execution, where the delay would also include the handover execution time. On the other hand, in the case of a conditional reconfiguration scenario, if the DRB configuration is updated towards the UE for the current cell, the conditional reconfigurations also need to be modified to reflect this new DBR change so that after the CHO (or CPC/CPA) execution the configurations are aligned at UE and target node. This would however introduce an additional delay in preparing the target configurations for this change and including them along with the DRB configuration for the serving cell.

Thus, broadly speaking, the problem is that for every DRB configuration update (e.g., addition, deletion, modification) or, more generically, ever user plane configuration update, those re-configurations towards the UE would be repeated. This problem would be especially exacerbated for selective activation, where the prepared cells are maintained, even after the conditional cell change has been executed.

To summarize the above, there may be generally considered to exist the following two issues related to conventional techniques, namely:
the signaling latency and internal signaling overhead for user plane configuration update (such as DRB configuration changes) during the CHO/CP(A)C execution window is increased due to updates being needed across multiple target cells prior to propagating user plane configuration update (e.g., the DRB configuration change) towards the UE; and
the re-configuration after each DRB change at SCG for CP(A)C appears to counter the general goal of allowing subsequent cell group change after changing CG without reconfiguration and re-initiation of CPC/CPA.

Thus, there is a need to propose new mechanisms/techniques for use in supporting conditional mobility use cases (e.g., CHO, CPC/CPA, or the like) in order to address some or all of the above-illustrated issues, particularly in an efficient, flexible yet reliable manner.

### SUMMARY

In accordance with an aspect of the present disclosure, there is provided a method for supporting a conditional mobility procedure involving a source network element serving a user equipment (UE) and at least one target network element, the method comprising:
obtaining a first delta radio resource control (RRC) configuration that is indicative of a difference between an RRC configuration of the source network element and an RRC configuration of the target network element;
storing the first delta RRC configuration;
obtaining a second delta RRC configuration that is indicative of a difference between an RRC configuration of the source network element and an RRC configuration of the target network element after a user plane configuration of the UE has been updated;
comparing the obtained second delta RRC configuration with the stored first delta RRC configuration to determine whether the first and second delta RRC configurations are identical or not;
based on determining that the first and second delta RRC configurations are not identical:
   transmitting an RRC reconfiguration message to the UE; and;
based on determining that the first and second delta RRC configurations are identical:
   skipping the transmission of the RRC reconfiguration message to the UE.

In some examples, the first delta RRC configuration is stored by the source network element; and the first and second delta RRC configurations are compared by the source network element.

In some examples, the obtaining of the first RRC configuration comprises:
transmitting, by the source network element, a first request message indicative of the conditional mobility procedure to the target network element; and
receiving, by the source network element, the first delta RRC configuration from the target network element.

In some examples, the obtaining of the second RRC configuration comprises:
transmitting, by the source network element, a second request message indicative of the update of the user plane configuration of the UE to the target network element; and
receiving, by the source network element, the second delta RRC configuration from the target network element.

In some examples,
based on determining that the first and second delta RRC configurations are not identical:
   transmitting, by the source network element, the RRC reconfiguration message to the UE for conveying the RRC configuration of the target network element for the conditional mobility procedure with respect to the updated user plane configuration; and based on determining that the first and second delta RRC configurations are identical:
   skipping, by the source network element, the transmission of the RRC reconfiguration message to the UE.

In some examples, the first delta RRC configuration is stored by the target network element; and the first and second delta RRC configurations are compared by the target network element.

In some examples, the obtaining of the first RRC configuration comprises:
receiving, by the target network element, a first request message indicative of the conditional mobility procedure from the source network element; and
generating, by the target network element, the first delta RRC configuration.

In some examples, the obtaining of the second RRC configuration comprises:
receiving, by the target network element, a second request message indicative of the update of the user plane configuration of the UE from the source network element; and
generating, by the target network element, the second delta RRC configuration based on the updated user plane configuration.

In some examples,
based on determining that the first and second delta RRC configurations are not identical:
   transmitting, by the target network element, the second delta RRC configuration to the source network element, and
   transmitting, by the source network element, the RRC reconfiguration message to the UE for conveying the RRC configuration of the target network element for the conditional mobility procedure with respect to the updated user plane configuration; and based on determining that the first and second delta RRC configurations are identical:
transmitting, by the target network element, information indicative of the first and second delta RRC configurations being identical to the source network element
skipping, by the source network element, the transmission of the RRC reconfiguration message to the UE based on the information indicative of the first and second delta RRC configurations being identical.

In some examples, the first and second delta RRC configurations being identical is indicated by at least one of: a flag, a value, a bitmap, or an absence of the transmission of the second delta RRC configuration or a part thereof.

In some examples, the conditional mobility procedure involves a conditional handover (CHO) procedure.

In some examples, the source and target network elements are each a gNB.

In some examples, the conditional mobility procedure involves a conditional PSCell change (CPC) procedure or a conditional PSCell addition (CPA) procedure.

In some examples, the source network element is a master node (MN) and the target network element is a secondary node (SN).

In accordance with another aspect of the present disclosure, there is provided a communication system comprising a source network element, at least one target network and a user equipment (UE) served by the source network element, wherein the communication system is configured for performing the method as disclosed in the present disclosure.

In accordance with yet another aspect of the present disclosure, there is provided a source network element configured for supporting a conditional mobility procedure involving at least one target network and a user equipment (UE) served by the source network element, the source network element comprising:
at least one processor; and
at least one memory storing instructions that, when executed by the at least one processor, cause the source network element at least to:
   obtain a first delta radio resource control (RRC) configuration that is indicative of a difference between an RRC configuration of the source network element and an RRC configuration of the target network element;
   store the first delta RRC configuration;
   obtain a second delta RRC configuration that is indicative of a difference between an RRC configuration of the source network element and an RRC configuration of the target network element after a user plane configuration of the UE is updated;
   compare the obtained second delta RRC configuration with the stored first delta RRC configuration to determine whether the first and second delta RRC configurations are identical or not;
   based on determining that the first and second delta RRC configurations are not identical:
      transmit an RRC reconfiguration message to the UE; and
   based on determining that the first and second delta RRC configurations are identical:
      skip the transmission of the RRC reconfiguration message to the UE.

In some examples, the source network element obtains the first delta RRC configuration by: receiving, from the target network element, the first delta RRC configuration in response to a first request message indicative of the conditional mobility procedure sent to the target network element; and the source network element obtains the second delta RRC configuration by: receiving, from the target network element, the second delta RRC configuration in response to a second request message indicative of the conditional mobility procedure sent to the target network element.

In some examples, when the conditional mobility procedure involves a conditional handover (CHO) procedure, the source network element is a gNB, and the first and second conditional mobility procedure requests are conditional handover requests; or when the conditional mobility procedure involves a conditional PSCell change (CPC) procedure or a conditional PSCell addition (CPA) procedure, the source network element is a master node (MN), and the first and second conditional mobility procedure requests are SN addition requests.

In accordance with yet another aspect of the present disclosure, there is provided a target network element configured for supporting a conditional mobility procedure involving a source network element serving a user equipment (UE) and the target network element, the target network element comprising:
at least one processor; and
at least one memory storing instructions that, when executed by the at least one processor, cause the target network element at least to:
   obtain a first delta radio resource control (RRC) configuration that is indicative of a difference between an RRC configuration of the source network element and an RRC configuration of the target network element;
   store the first delta RRC configuration;
   obtain a second delta RRC configuration that is indicative of a difference between an RRC configuration of the source network element and an RRC configuration of the target network element after a user plane configuration of the UE is updated;
   compare the obtained second delta RRC configuration with the stored first delta RRC configuration to determine whether the first and second delta RRC configurations are identical or not;
   based on determining that the first and second delta RRC configurations are not identical:
      transmit the second delta RRC configuration to the source network element, for enabling the source network element to transmit an RRC reconfiguration message to the UE; and
   based on determining that the first and second delta RRC configurations are identical:
      transmit information indicative of the first and second delta RRC configurations being identical to the source network element, such that transmission of the RRC reconfiguration message from the source network element to the UE can be skipped.

In some examples, the target network element obtains the first delta RRC configuration by: generating, by the target network element, the first delta RRC configuration based on a received first request message indicative of the conditional mobility procedure; and the target network element obtains the second delta RRC configuration by: generating, by the target network element, the second delta RRC configuration based on a received second request message indicative of the conditional mobility procedure.

In some examples, when the conditional mobility procedure involves a conditional handover (CHO) procedure, the target network element is a gNB, and the first and second conditional mobility procedure requests are conditional handover requests; or when the conditional mobility procedure involves a conditional PSCell change (CPC) procedure or a conditional PSCell addition (CPA) procedure, the target network element is a secondary node (SN), and the first and second conditional mobility procedure requests are SN addition requests.

In accordance with yet another aspect of the present disclosure, there is provided a source network element configured for supporting a conditional mobility procedure involving at least one target network and a user equipment (UE) served by the source network element, the source network element comprising:
at least one processor; and
at least one memory storing instructions that, when executed by the at least one processor, cause the source network element at least to:
transmit a first request message indicative of the conditional mobility procedure to the target network element;
receive a first delta RRC configuration from the target network element in response to the first conditional mobility procedure request;
based on the received first delta RRC configuration, transmit a first RRC reconfiguration message to the UE conveying the RRC configuration of the target network element for the conditional mobility procedure;
in response to updating a user plane configuration of the UE, send a second request message indicative of the conditional mobility procedure to the target network element;
when receiving a second delta RRC configuration from the target network element in response to the second conditional mobility procedure request:
   transmit a second RRC reconfiguration message to the UE; and
when information indicative of the delta RRC configuration having not been changed is received from the target network element in response to the second conditional mobility request:
   skip the transmission of the second RRC reconfiguration message to the UE.

According to some example embodiments, there is also provided a computer program comprising instructions for causing an apparatus or a system to perform the method as disclosed in the present disclosure.

According to some example embodiments, there is also provided a memory storing computer readable instructions for causing an apparatus or a system to perform the method as disclosed in the present disclosure

Furthermore, according to some example embodiments, there is provided a source network element configured for supporting a conditional mobility procedure involving a user equipment (UE) served by the source network element and at least one target network element, the source network element comprising respective suitable means configured for performing the respective steps as disclosed in the present disclosure.

Similarly, according to some example embodiments, there is also provided a target network element configured for supporting a conditional mobility procedure involving a source network element serving a user equipment (UE) and the target network element, the target network element comprising respective suitable means configured for performing the respective steps as disclosed in the present disclosure.

In addition, according to some other example embodiments, there is provided, for example, a computer program product for a wireless communication device comprising at least one processor, including software code portions for performing the respective steps disclosed in the present disclosure, when said product is run on the device. The computer program product may include a computer-readable medium on which said software code portions are stored. Furthermore, the computer program product may be directly loadable into the internal memory of the computer and/or transmittable via a network by means of at least one of upload, download and push procedures.

While some example embodiments will be described herein with particular reference to the above application, it will be appreciated that the present disclosure is not limited to such a field of use, and is applicable in broader contexts.

Notably, it is understood that methods according to the present disclosure relate to methods of operating the apparatuses (or systems) according to the above example embodiments and variations thereof, and that respective statements made with regard to the apparatuses (or systems) likewise apply to the corresponding methods, and vice versa, such that similar description may be omitted for the sake of conciseness. In addition, the above aspects may be combined in many ways, even if not explicitly disclosed. The skilled person will understand that these combinations of aspects and features/steps are possible unless it creates a contradiction which is explicitly excluded.

Implementations of the disclosed apparatuses may include using, but not limited to, one or more processor, one or more application specific integrated circuit (ASIC) and/or one or more field programmable gate array (FPGA). Implementations of the apparatus may also include using other conventional and/or customized hardware such as software programmable processors, such as graphics processing unit (GPU) processors.

Other and further example embodiments of the present disclosure will become apparent during the course of the following discussion and by reference to the accompanying drawings.

### BRIEF DESCRIPTION OF THE DRAWINGS

Example embodiments of the disclosure will now be described, by way of example only, with reference to the accompanying drawings in which:

FIG. 1 schematically illustrates an example of a conditional handover (CHO) signaling/messaging flowchart according to some examples of the present disclosure;

FIG. 2 schematically illustrates an example of a conditional PSCell change/addition (CPC/CPA) signaling/messaging flowchart according to some examples of the present disclosure;

FIG. 3 schematically illustrates an example of a configuration update for CHO according to some examples of the present disclosure;

FIG. 4 schematically illustrates an example of a configuration update for CPC/CPA according to some examples of the present disclosure;

FIG. 5 schematically illustrates an example of a configuration update for CHO according to some example embodiments of the present disclosure;

FIG. 6 schematically illustrates an example of a configuration update for CPC/CPA according to some example embodiments of the present disclosure;

FIG. 7 schematically illustrates another example of a configuration update for CHO according to some example embodiments of the present disclosure;

FIG. 8 schematically illustrates another example of a configuration update for CPC/CPA according to some example embodiments of the present disclosure;

FIGS. 9A and 9B schematically illustrate examples of a communication network/system architecture according to some example embodiments of the present disclosure; and

FIG. 10 schematically illustrates an example of an implementation of an apparatus according to some example embodiments of the present disclosure.

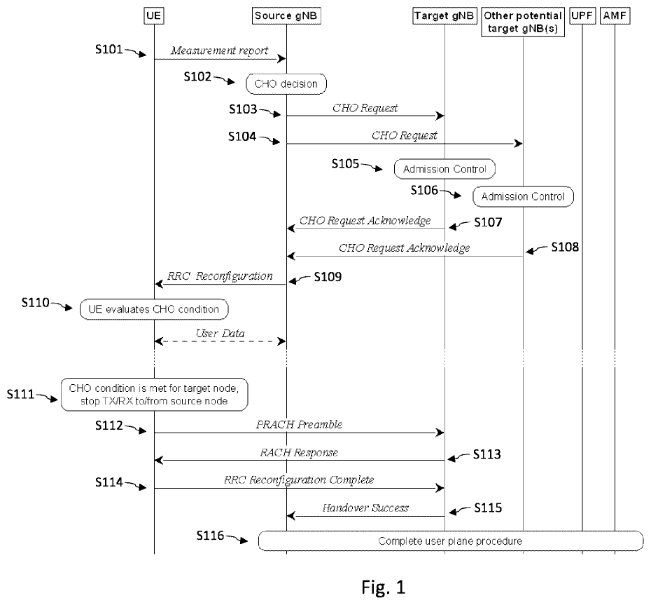

### DESCRIPTION OF EXAMPLE EMBODIMENTS

Notably, identical or like reference numbers used in the figures of the present disclosure may, unless indicated otherwise, indicate identical or like elements. Similarly, identical or like messages (as well as the contents comprised therein) used in the figures of the present disclosure may, unless indicated otherwise, indicate identical or like messages (and the contents therein), such that repeated description thereof may be omitted for reasons of conciseness.

In the following, different exemplifying embodiments will be described using, as an example of a communication network to which examples of embodiments may be applied, a communication network architecture based on 3GPP standards for a communication network, such as a 5G/NR, without restricting the embodiments to such an architecture, however. It is apparent for a person skilled in the art that the embodiments may also be applied to other kinds of communication networks where mobile communication principles are integrated with a D2D (device-to-device) or V2X (vehicle to everything) configuration, such as SL (side link), e.g. Wi-Fi, worldwide interoperability for microwave access (WiMAX), Bluetooth®, personal communications services (PCS), ZigBee®, wideband code division multiple access (WCDMA), systems using ultra-wideband (UWB) technology, mobile ad-hoc networks (MANETs), wired access, etc. Furthermore, without loss of generality, the description of some examples of embodiments is related to a mobile communication network, but principles of the disclosure can be extended and applied to any other type of communication network, such as a wired communication network.

The following examples and embodiments are to be understood only as illustrative examples. Although the specification may refer to “an”, “one”, or “some” example(s) or embodiment(s) in several locations, this does not necessarily mean that each such reference is related to the same example(s) or embodiment(s), or that the feature only applies to a single example or embodiment. Single features of different embodiments may also be combined to provide other embodiments. Furthermore, terms like “comprising” and “including” should be understood as not limiting the described embodiments to consist of only those features that have been mentioned; such examples and embodiments may also contain features, structures, units, modules, etc., that have not been specifically mentioned.

A basic system architecture of a (tele) communication network including a mobile communication system where some examples of embodiments are applicable may include an architecture of one or more communication networks including wireless access network subsystem(s) and core network(s). Such an architecture may include one or more communication network control elements or functions, access network elements, radio access network elements, access service network gateways or base transceiver stations, such as a base station (BS), an access point (AP), a NodeB (NB), an eNB or a gNB, a distributed unit (DU) or a centralized/central unit (CU), which controls a respective coverage area or cell(s) and with which one or more communication stations such as communication elements or functions, like user devices or terminal devices, like a user equipment (UE), or another device having a similar function, such as a modem chipset, a chip, a module etc., which can also be part of a station, an element, a function or an application capable of conducting a communication, such as a UE, an element or function usable in a machine-to-machine communication architecture, or attached as a separate element to such an element, function or application capable of conducting a communication, or the like, are capable to communicate via one or more channels via one or more communication beams for transmitting several types of data in a plurality of access domains. Furthermore, core network elements or network functions, such as gateway network elements/functions, mobility management entities, a mobile switching center, servers, databases and the like may be included.

The following description may provide further details of alternatives, modifications and variances: a gNB comprises e.g., a node providing NR user plane and control plane protocol terminations towards the UE, and connected via the NG interface to the 5GC, e.g., according to 3GPP TS 38.300 V16.6.0 (2021-06) section 3.2 incorporated by reference.

A gNB Central Unit (gNB-CU) comprises e.g., a logical node hosting e.g., RRC, SDAP and PDCP protocols of the gNB or RRC and PDCP protocols of the en-gNB that controls the operation of one or more gNB-DUs. The gNB-CU terminates the F1 interface connected with the gNB-DU.

A gNB Distributed Unit (gNB-DU) comprises e.g., a logical node hosting e.g., RLC, MAC and PHY layers of the gNB or en-gNB, and its operation is partly controlled by the gNB-CU. One gNB-DU supports one or multiple cells. One cell is supported by only one gNB-DU. The gNB-DU terminates the F1 interface connected with the gNB-CU.

A gNB-CU-Control Plane (gNB-CU-CP) comprises e.g., a logical node hosting e.g., the RRC and the control plane part of the PDCP protocol of the gNB-CU for an en-gNB or a gNB. The gNB-CU-CP terminates the E1 interface connected with the gNB-CU-UP and the F1-C interface connected with the gNB-DU.

A gNB-CU-User Plane (gNB-CU-UP) comprises e.g., a logical node hosting e.g., the user plane part of the PDCP protocol of the gNB-CU for an en-gNB, and the user plane part of the PDCP protocol and the SDAP protocol of the gNB-CU for a gNB. The gNB-CU-UP terminates the E1 interface connected with the gNB-CU-CP and the F1-U interface connected with the gNB-DU, e.g., according to 3GPP TS 38.401 V16.6.0 (2021-07) section 3.1 incorporated by reference.

Different functional splits between the central and distributed unit are possible, e.g., called options:

### Option 1 (1A-Like Split):

The function split in this option is similar to the 1A architecture in DC. RRC is in the central unit. PDCP, RLC, MAC, physical layer and RF are in the distributed unit.

### Option 2 (3C-Like Split):

The function split in this option is similar to the 3C architecture in DC. RRC and PDCP are in the central unit. RLC, MAC, physical layer and RF are in the distributed unit.

### Option 3 (Intra RLC Split):

Low RLC (partial function of RLC), MAC, physical layer and RF are in the distributed unit. PDCP and high RLC (the other partial function of RLC) are in the central unit.

### Option 4 (RLC-MAC Split):

MAC, physical layer and RF are in the distributed unit. PDCP and RLC are in the central unit.
   Or else, e.g., according to 3GPP TR 38.801 V14.0.0 (2017-03) section 11 incorporated by reference.

A gNB supports different protocol layers, e.g., Layer 1 (L1)—physical layer.

The layer 2 (L2) of NR is split into the following sublayers: Medium Access Control (MAC), Radio Link Control (RLC), Packet Data Convergence Protocol (PDCP) and Service Data Adaptation Protocol (SDAP), where e.g.:
The physical layer offers to the MAC sublayer transport channels;
The MAC sublayer offers to the RLC sublayer logical channels;
The RLC sublayer offers to the PDCP sublayer RLC channels;
The PDCP sublayer offers to the SDAP sublayer radio bearers;
The SDAP sublayer offers to 5GC QoS flows;
Comp. refers to header compression and Segm. To segmentation;
Control channels include (BCCH, PCCH).

Layer 3 (L3) includes e.g., Radio Resource Control (RRC), e.g., according to 3GPP TS 38.300 V16.6.0 (2021-06) section 6 incorporated by reference.

A RAN (Radio Access Network) node or network node like e.g. a gNB, base station, gNB CU or gNB DU or parts thereof may be implemented using e.g. an apparatus with at least one processor and/or at least one memory (with computer-readable instructions (computer program)) configured to support and/or provision and/or process CU and/or DU related functionality and/or features, and/or at least one protocol (sub-)layer of a RAN (Radio Access Network), e.g. layer 2 and/or layer 3.

The gNB CU and gNB DU parts may e.g., be co-located or physically separated. The gNB DU may even be split further, e.g., into two parts, e.g., one including processing equipment and one including an antenna. A Central Unit (CU) may also be called BBU/REC/RCC/C-RAN/V-RAN, O-RAN, or part thereof. A Distributed Unit (DU) may also be called RRH/RRU/RE/RU, or part thereof. Hereinafter, in various example embodiments of the present disclosure, the CU-CP (or more generically, the CU) may also be referred to as a (first) network node that supports at least one of central unit control plane functionality or a layer 3 protocol of a radio access network; and similarly, the DU may be referred to as a (second) network node that supports at least one of distributed unit functionality or the layer 2 protocol of the radio access network.

A gNB-DU supports one or multiple cells, and could thus serve as e.g., a serving cell for a user equipment (UE).

A user equipment (UE) may include a wireless or mobile device, an apparatus with a radio interface to interact with a RAN (Radio Access Network), a smartphone, an in-vehicle apparatus, an IoT device, a M2M device, or else. Such UE or apparatus may comprise: at least one processor; and at least one memory including computer program code; wherein the at least one memory and the computer program code are configured to, with the at least one processor, cause the apparatus at least to perform certain operations, like e.g. RRC connection to the RAN. A UE is e.g., configured to generate a message (e.g., including a cell ID) to be transmitted via radio towards a RAN (e.g., to reach and communicate with a serving cell). A UE may generate and transmit and receive RRC messages containing one or more RRC PDUs (Packet Data Units).

The UE may have different states (e.g., according to 3GPP TS 38.331 V16.5.0 (2021-06) sections 42.1 and 4.4, incorporated by reference).

A UE is e.g., either in RRC_CONNECTED state or in RRC_INACTIVE state when an RRC connection has been established.

In RRC_CONNECTED state a UE may:
store the AS context;
transfer unicast data to/from the UE;
monitor control channels associated with the shared data channel to determine if data is scheduled for the data channel;
provide channel quality and feedback information;
perform neighboring cell measurements and measurement reporting.

The RRC protocol includes e.g. the following main functions:
RRC connection control;
measurement configuration and reporting;
establishment/modification/release of measurement configuration (e.g. intra-frequency, inter-frequency and inter-RAT measurements);
setup and release of measurement gaps;
measurement reporting.

The general functions and interconnections of the described elements and functions, which also depend on the actual network type, are known to those skilled in the art and described in corresponding specifications, so that a detailed description thereof may omitted herein for the sake of conciseness. However, it is to be noted that several additional network elements and signaling links may be employed for a communication to or from an element, function or application, like a communication endpoint, a communication network control element, such as a server, a gateway, a radio network controller, and other elements of the same or other communication networks besides those described in detail herein below.

A communication network architecture as being considered in examples of embodiments may also be able to communicate with other networks, such as a public switched telephone network or the Internet. The communication network may also be able to support the usage of cloud services for virtual network elements or functions thereof, wherein it is to be noted that the virtual network part of the telecommunication network can also be provided by non-cloud resources, e.g., an internal network or the like. It should be appreciated that network elements of an access system, of a core network etc., and/or respective functionalities may be implemented by using any node, host, server, access node or entity etc. being suitable for such a usage. Generally, a network function can be implemented either as a network element on a dedicated hardware, as a software instance running on a dedicated hardware, or as a virtualized function instantiated on an appropriate platform, e.g., a cloud infrastructure.

Furthermore, a network element, such as communication elements, like a UE, a terminal device, control elements or functions, such as access network elements, like a base station/BS, a gNB, a radio network controller, a core network control element or function, such as a gateway element, or other network elements or functions, as described herein, and any other elements, functions or applications may be implemented by software, e.g., by a computer program product for a computer, and/or by hardware. For executing their respective processing, correspondingly used devices, nodes, functions or network elements may include several means, modules, units, components, etc. (not shown) which are required for control, processing and/or communication/signaling functionality. Such means, modules, units and components may include, for example, one or more processors or processor units including one or more processing portions for executing instructions and/or programs and/or for processing data, storage or memory units or means for storing instructions, programs and/or data, for serving as a work area of the processor or processing portion and the like (e.g. ROM, RAM, EEPROM, and the like), input or interface means for inputting data and instructions by software (e.g. floppy disc, CD-ROM, EEPROM, and the like), a user interface for providing monitor and manipulation possibilities to a user (e.g. a screen, a keyboard and the like), other interface or means for establishing links and/or connections under the control of the processor unit or portion (e.g. wired and wireless interface means, radio interface means including e.g. an antenna unit or the like, means for forming a radio communication part etc.) and the like, wherein respective means forming an interface, such as a radio communication part, can be also located on a remote site (e.g. a radio head or a radio station etc.). It is to be noted that in the present specification processing portions should not be only considered to represent physical portions of one or more processors, but may also be considered as a logical division of the referred processing tasks performed by one or more processors. It should be appreciated that according to some examples, a so-called “liquid” or flexible network concept may be employed where the operations and functionalities of a network element, a network function, or of another entity of the network, may be performed in different entities or functions, such as in a node, host or server, in a flexible manner. In other words, a “division of labor” between involved network elements, functions or entities may vary case by case.

As illustrated above, the conditional handover (CHO) procedure has been introduced to improve mobility robustness. In particular, in the case of CHO, the network may prepare multiple target cells where each conditional handover reconfiguration is associated with a CHO execution condition that is evaluated by the UE. The CHO execution condition may refer to a measurement ID associating a measurement object with a reporting configuration and may be configured by source gNB. The reporting configuration may generally define the measurement event (e.g., A3 or A5) which may trigger the reporting of the configured measurements. The same measurement events may also be configured by the UE which would trigger the CHO execution upon the configured measurement configuration is met. Whenever a CHO execution condition is met, the corresponding target configuration is selected, and the handover is executed towards the selected target cell. In short, the CHO procedure may generally be seen as being designed so that UE can execute the handover autonomously without the need for the serving cell to trigger the handover (HO) execution after receiving a measurement report from the UE.

In particular, the main steps of such a CHO procedure might be summarized as follows.

In step S101, UE sends the measurement report identifying potential neighbor cells for handover.

Subsequently in steps S102-S108, particularly in response to the measurements received in step S101, the source gNB determines that the target cells with CHO should be prepared for the UE. Accordingly, the source gNB sends conditional Handover Request (or the like) to multiple target gNBs. In each CHO request message, the source gNB indicates the target PCell that shall be prepared by target gNB. The target gNB does the admission control and sends Handover Request ACK for the requested PCell and the related conditional configuration as a response to the Handover request.

In step S109, the source gNB sends the RRC Reconfiguration with the conditional configurations related to the CHO to the UE.

The UE then evaluates, as shown in steps S110-S111, the CHO conditions, and executes the conditional configuration for the CHO for which the condition is held; and executes, as exemplarily shown in steps S111-S114, the CHO towards the target cell controlled by the target gNB.

In step S115, the target gNB indicates the handover success to the source gNB.

Then, the user plane procedures such as data forwarding and path switch are completed afterwards, as exemplified in step S116.

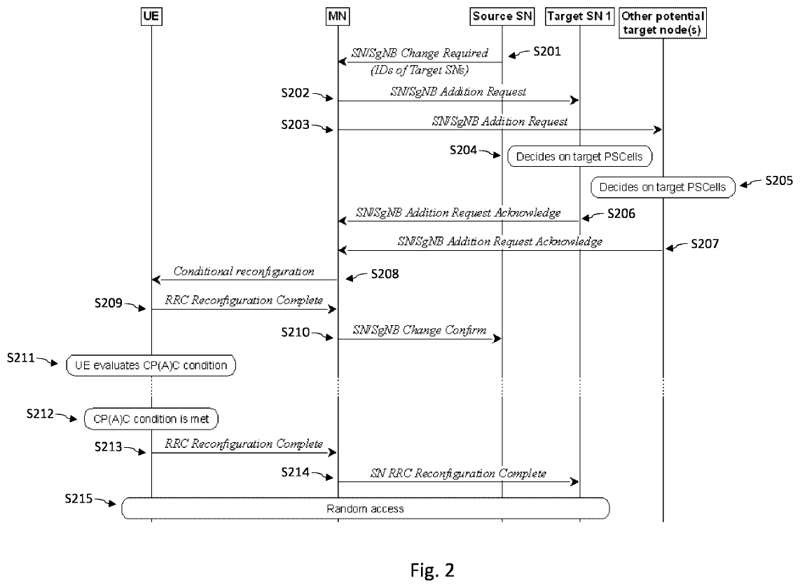

Similarly, FIG. 2 is a schematical high-level illustration of the main signaling/messaging steps of a conditional PSCell change/addition (CPC/CPA) procedure, which will now be described in more detail below. Specifically, the example as shown in FIG. 2 may be understood as a CPC/CPA procedure that is initiated by a secondary node (SN). As can be understood and appreciated by the skilled person, the SN may be generally used to refer to a radio access node (e.g., deployed in Multi-RAT (radio access technology) Dual Connectivity (MR-DC) techniques/systems) that has no control plane connection to the core network and that is for providing additional resources to the UE. Depending on various possible technologies, an SN may be implemented as an en-gNB (e.g., in EN-DC, i.e., E-UTRA-NR Dual Connectivity), a secondary ng-eNB (e.g., in NE-DC, i.e., NR-E-UTRA Dual Connectivity), a secondary gNB (e.g., in NR-DC and NGEN-DC), or the like. Correspondingly, a master node (MN) may be generally used to refer to a radio access node (e.g., deployed in MR-DC techniques/systems) that provides the control plane connection to the core network. Depending on various possible technologies, an MN may be implemented as a master eNB (e.g., in EN-DC), a master ng-eNB (e.g., in NGEN-DC), a master gNB (e.g., in NR-DC and NE-DC), or the like.

Now referring to FIG. 2, in step S201, the source SN indicates to the MN the IDs of the target SNs that shall be contacted for preparing the target PSCell(s). The source SN may suggest a list of PSCell(s) to be prepared by each target SN and provide a CPC execution condition for each suggested target PSCell.

In steps S202 and S203, the MN sends for example an addition request to each target SN indicated by the source SN, including, among others, the PSCells suggested by the source SN.

Subsequently, in steps S204 and S205, the target SN may decide on the candidate target PSCell(s) to prepare among the suggested list of PSCells to be prepared.

In steps S206 and S207, the target SN sends to the MN the CPC configuration for each prepared target PSCell and also the corresponding ID(s) of the prepared target PSCell(s).

Then in step S208, the MN sends to the UE a (conditional) (re-)configuration (e.g., in any suitable message) containing the CPC configuration(s) of the candidate target PSCell(s) along with the respective CPC execution condition(s).

In step S209, the UE sends a corresponding message (e.g., as an RRC Reconfiguration Complete message or in any other suitable message form/format) to the MN confirming the reception of the conditional configuration, and the MN confirms in turn to the source SN the SN change preparation in step S210.

Later, the UE evaluates, as shown in step S211, the CPC execution conditions of the prepared target PSCell(s).

When the CPC execution condition is met for e.g. a PSCell candidate in target SN 1, as shown in step S212, the UE may send a message to MN in step S13 indicating the execution of the CPC configuration. The message may include, among others, an SN RRC Reconfiguration Complete to the target SN 1 which is sent (by the MN) in step S214.

And finally, the UE may perform a random access procedure as shown in step S215, as can be understood and appreciated by the skilled person.

As has been noted above already, when the user plane configuration of the UE is updated (e.g., new bearers are configured, QoS flows created for radio resource control (RRC) connection, or the like), the RRC reconfiguration (e.g., for the modified DRB configuration) would have to be provided to the UE, which may however introduce undesirable signaling latency and internal signaling overhead due to the fact that the update(s) (e.g., the DRB configuration change) would generally be needed across multiple target cells prior to being propagated towards the UE.

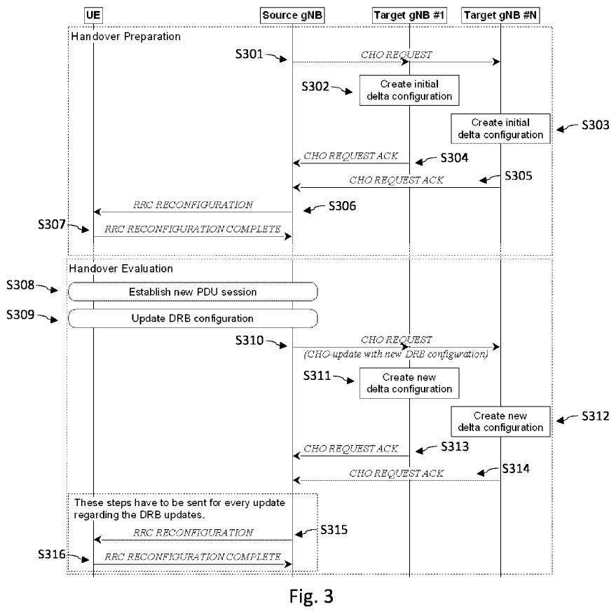

For instance, FIG. 3 schematically illustrates an example where in the case of CHO, following every update of the DRB configurations or the like (as exemplified in steps S308 and S309), radio signaling of steps S315 and S316 would have to be sent over the air between the UE and the source gNB.

To be more specific, after a release or an establishment of a PDU session (step S308) the DRB configuration of the UE is updated (step S309) by the source cell (gNB). As a next step S310, the DRB configuration change is indicated to all nodes controlling the candidate cells. The nodes controlling the candidate cells update the UE DRB configuration (as exemplified in steps S311 and S312) and send the configuration back to the UE (steps S313 and sS314). As explained above, such updating of the configuration would be subject to delay and at the same time also require additional signaling; and, as a result, the UE would need to be reconfigured after the initial configuration.

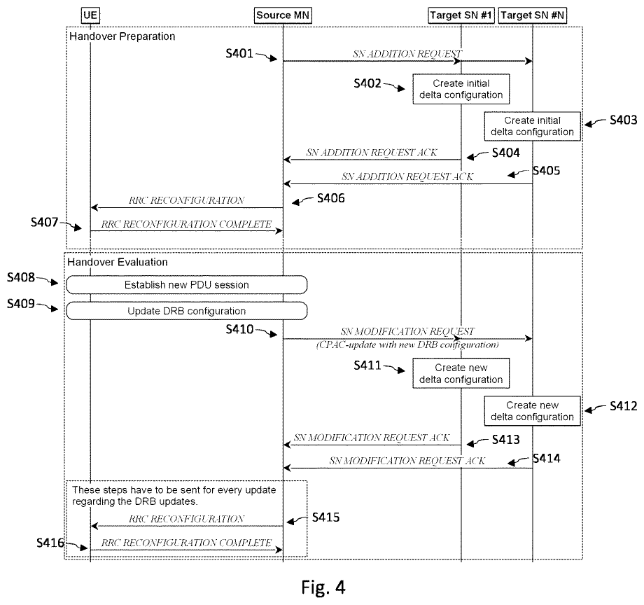

Similar issues/problems generally also exist for the case of CPC update (or, in some possible cases, also CPA scenarios) with interactions happening between source MN and target SNs, as schematically shown in FIG. 4. That is, in the case of CPC, following every update of the DRB configurations, radio signaling of step S415 and step S416 would have to be sent over the air between the UE and the source MN, thereby resulting in signaling delay and overhead. Notably, since the main steps as shown in FIG. 4 appear to be more or less similar to those as shown in FIG. 3 (except for the different network elements being involved, and as a result, different messaging/signaling being exchanged between those network elements), the respective steps of FIG. 4 are not described in detail, for the sake of conciseness.

For the sake of completeness, it is also noticed that some other possible (conventional) techniques may exhibit various issues or problems as well, such as requiring non-straightforward coordination between the source and target network elements

In view thereof, the present disclosure generally proposes mechanisms/techniques for use in supporting such conditional mobility use cases (e.g., CHO, CPC/CPA, or the like), particularly in an efficient, flexible yet reliable manner. Broadly speaking, in order to overcome the excessive signaling (which is caused by the update of the user plane configuration, such as DRB updates, as illustrated above), it is generally proposed to compare the newly created delta configurations of the candidate cells in the target node(s) with the initial delta configurations before the newly created delta configuration are generated.

For ease of understanding, Tables 1 and 2 schematically illustrate exemplary (non-limiting) RRC configurations for the UE by the source node and the target node (shown in the full or delta format), before and after a possible DRB update (which is merely used as one possible, non-limiting example for illustrating the user plane configuration), respectively. Notably, in the present example, DRB 2 and correspondingly also the QoS flow 2 mapped to DRB 2 are deleted/removed. Thus, as can be understood and appreciated by the skilled person, the (target) delta configuration (as shown in the third column in both tables) generally indicates only the information elements (IEs) that are different from the source configuration.

TABLE 1
RRC Configurations before the DRB update

| | | Target |
|---|---|---|
| Source Config | Target Config | Delta Config |
| PCI 1 | PCI 2 | PCI 2 |
| DRB 1 | DRB 1 | TCI-state 4-5-6 |
| DRB 2 | DRB 2 | |
| QoS Flow 1 maps to DRB1 | QoS Flow 1 maps to DRB1 | |
| QoS Flow 2 maps to DRB2 | QoS Flow 2 maps to DRB2 | |
| TCI-state 1-2-3 | TCI-state 4-5-6 | |
| . . . | . . . | |

TABLE 2
RRC Configurations after the DRB update

| | | Target |
|---|---|---|
| Source Config | Target Config | Delta Config |
| PCI 1 | PCI 2 | PCI 2 |
| DRB 1 | DRB 1 | TCI-state 4-5-6 |
| QoS Flow 1 maps to DRB1 | QoS Flow 1 maps to DRB1 | |
| TCI-state 1-2-3 | TCI-state 4-5-6 | |
| . . . | . . . | |

As can be seen from the above tables, before the possible DRB update (Table 1), many of the configurations (as exemplarily listed in the first column representing the RRC configuration for the source network element and the second column representing the RRC configuration for the target network element) are identical, and as a result, are not included in the delta configuration (the third column). Later, after the possible DRB update, i.e., the deletion/removal of DRB 2 and the corresponding QoS flow 2 (Table 2), again only the non-identical elements are included inside the delta configuration. Specifically, since the newly created target delta configuration (after the DRB update) is identical to the initial delta configuration (before the DRB update), the source network element may be configured to skip sending the newly created delta configuration(s) to the UE(s), in order to reduce the excessive radio signaling.

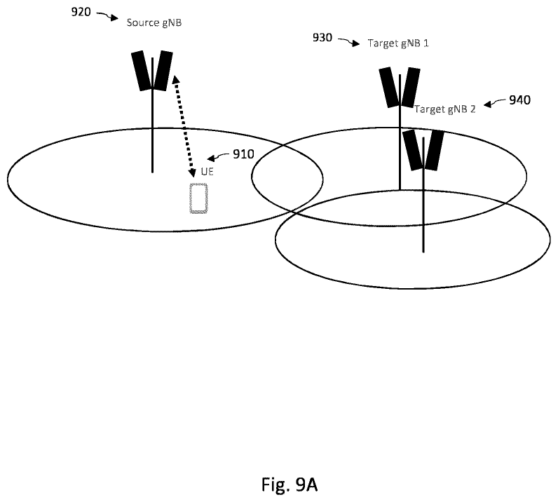

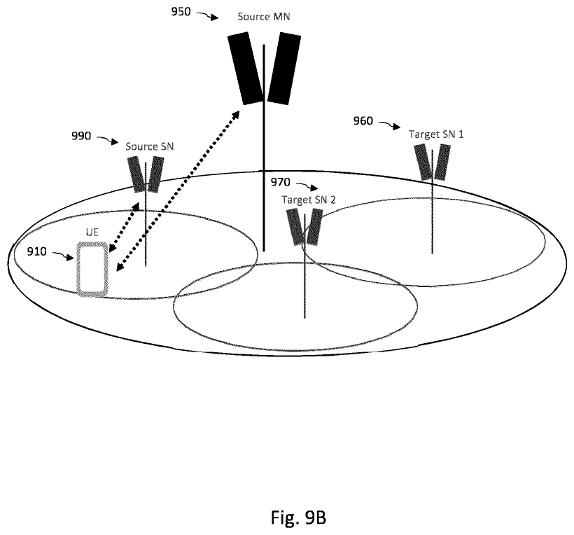

Before going into more technical detail about the proposed mechanisms/techniques themselves, it may be worthwhile to first introduce, from a high-level perspective, some possible system setups (architectures) that the proposed mechanisms/techniques might be considered applicable to. However, as can be understood and appreciated by the skilled person, these system setups (architectures) as shown in FIGS. 9A and 9B are merely provided as some possible illustrative examples and should in no way be understood as limitations of any kind.

In particular, FIG. 9A schematically shows a possible exemplary system setup for CHO use cases. Therein, a UE 910 is connected (as exemplified by the double-sided dash arrow) to the source gNB 920 (which has a serving area indicated by the circle). On the other side, under certain conditions, the UE may be configured with a CHO towards a potential set of target gNBs (as exemplarily shown as target gNB 1 930 and target gNB 2 940), each of which having a respective serving area indicated by the respective circle.

Similarly, FIG. 9B schematically shows a possible exemplary system setup for CP(A)C use cases. Therein, a UE 910 is connected (as exemplified by the double-sided dash arrow) to the source MN 950 (which has a serving area indicated by the bigger outer circle). On the other side, under certain conditions, the UE may be configured with a CPC/CPA towards a potential set of target SNs (as exemplarily shown as target SN 1 960 and target SN 2 970), each of which having a respective serving area indicated by the respective circle. In addition, in some possible implementations, the UE may also be connected to a source SN 990 (which has a serving area indicated by the smaller circle), for example in addition to the connection to the source MN 950 when being operated in a dual-connectivity setup (as shown in the example of FIG. 9B).

These proposed mechanisms/techniques will now be descried in more detail with reference to the figures. It is to be noted that, as indicated above, identical or like reference numbers used in the figures of the present disclosure may, unless indicated otherwise, indicate identical or like elements. Similarly, identical or like messages (as well as the contents comprised therein) used in the figures of the present disclosure may, unless indicated otherwise, indicate identical or like messages (and the contents therein), such that repeated description thereof may be omitted for reasons of conciseness.

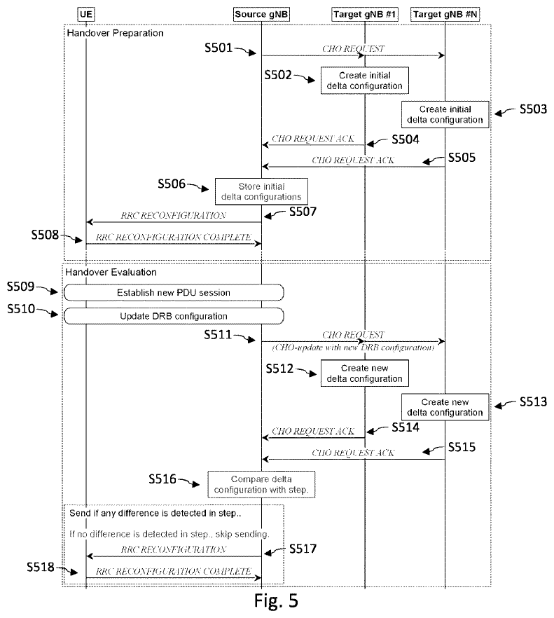

First, FIG. 5 schematically illustrates an example of a configuration update for CHO according to some example embodiments of the present disclosure.

In general, in the example of FIG. 5, it may be understood that, for the case of CHO, the source network element (the source gNB in the present example) may be configured to store the initial delta configurations that are received with for example CHO REQUEST ACK (or similar messages). After there is a change in user plane configuration (e.g., a PDU session is released or setup, or DRB to QoS flow mapping is updated, etc.), the source gNB may be configured to update the DRB configuration of the UE. Subsequently, the source gNB indicates such changes to the target gNB(s) and correspondingly receives the new delta configuration(s) from the target gNB(s). The source gNB may then be configured to compare the new delta configuration(s) with the respective initial delta configuration(s) that have been stored by the source gNB. If the new delta configuration(s) are identical to the initial delta configuration(s), the source gNB may be configured to not send the RRC RECONFIGURATION message(s) (or the like) to the UE. In other words, the source gNB may be configured to skip updating the conditional configuration(s) of the target cell(s) given that it/they has/have not been changed.

More specifically, as shown in FIG. 5, in step S501, the source gNB sends the CHO REQUEST (or other similar, suitable messages) to (each of) the target gNB(s) (numbered #1 to #N). As can be understood and appreciated by the skilled person, even though, for ease of illustration, two target gNBs (numbered #1 and #N, respectively) are illustrated in the example of FIG. 5, any other suitable number of target gNBs (even only one, in some possible cases) may be possible as well, depending on various implementations and/or requirements.

Subsequently, in steps S502 and S503, the target gNBs may be configured to obtain (e.g., generate, determine, or by using any other suitable means) a respective (initial) delta of the RRC configuration for each of the target cells. As can be understood and appreciated by the skilled person, the delta configurations are generated based on the source and target cell configurations (see also the above illustration with reference to Tables 1 and 2).

In steps S504 and S505, the target gNBs may acknowledge the CHO requests with for example the CHO REQUEST ACK along with the delta configurations, which are sent back from the target gNBs to the source gNB.

In step S506, the source gNB may be configured to store (e.g., in a suitable memory or the like) the delta configurations, which are received from the target gNBs in steps S504 and S505.

Afterwards, in steps S507 and S508, the RRC reconfigurations with the delta configurations for CHO are sent from the source gNB to the UE (step S507) and, in return, the UE sends the RRC reconfiguration complete back to the source gNB (step S508).

As exemplified in steps S509 and S510, the user plane configuration may be updated (e.g., a PDU session is released or setup, or DRB to QoS flow mapping is updated, etc.), and possibly also the corresponding DRB configurations may be updated.

As a result, in step S511, the source gNB sends a new set of CHO REQUESTS with the updated DRB configurations (or the like) to the respective target gNBs.

Accordingly, the target gNBs may accept or reject the changes to the DRB configurations (or the like). In case the changes would be accepted, the target gNBs may update the user RRC configuration and obtain (e.g., generate) the corresponding new delta configurations in response to such updated user plane configurations (e.g., DRB configurations), as exemplified in steps S512 and S513.

In steps S514 and S515, the target gNBs acknowledge the CHO requests with respective CHO REQUEST ACKs (or the like), along with the new delta configurations, which are sent back to the source gNB.

Therein, as exemplarily shown in step S516, the source gNB may be configured to compare the received new set of the delta configurations with the already stored initial delta configurations.

If there would be a difference detected (e.g., for any of the pair of respective delta configurations before and after the user plane update) in step S516, the corresponding delta configuration(s) is/are sent by the source gNB to the UE, in order to update the RRC configurations inside the CHO configuration in step S517. Correspondingly, the UE may acknowledge such re-configuration as exemplified in step S518. Notably, depending on various implementations and/or requirements, the source gNB may be configured to prepare and transmit separate RRC reconfiguration messages (for each of the detected differences in the delta configurations), or one (concatenated) RRC reconfiguration message (e.g., having different delta configurations for different target cells as different IEs within the single RRC reconfiguration message).

On the other hand, the re-configuration message(s) may be skipped if in step S516 the respective delta configurations would be found to be identical.

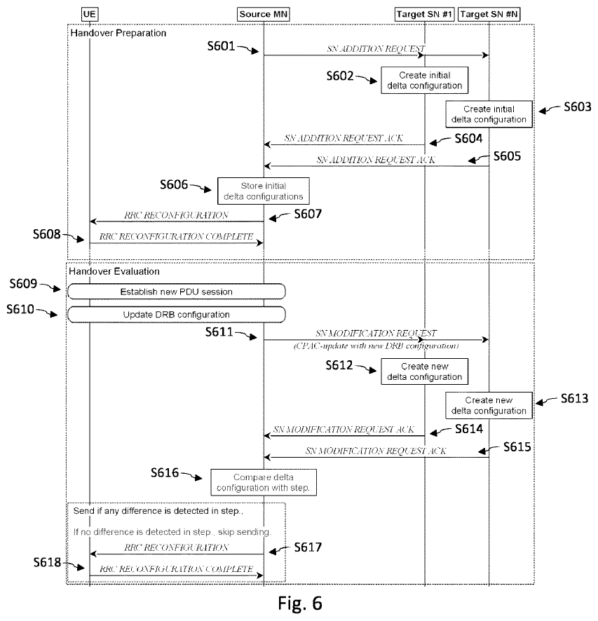

Secondly, FIG. 6 schematically illustrates an example of a configuration update for CPC/CPA according to some example embodiments of the present disclosure. As noted above, identical or like reference numbers or messages (as well as the contents comprised therein) used in the figures of the present disclosure may, unless indicated otherwise, indicate identical or like elements messages (and the respective contents therein), such that repeated description thereof may be omitted for reasons of conciseness.

Generally speaking, in the example of FIG. 6, it may be understood that, for the case of CP(A)C, the source MN may—similar to the source gNB as described in the above FIG. 5 with respect to the case of CHO—be configured to store the initial delta configurations that are received with for example the SN ADDITION REQUEST ACK (or similar messages). After there is a change in the user plane configuration (e.g., a PDU session is released or setup, or DRB to QoS flow mapping is updated, etc.), the source MN may be configured to update the DRB configuration of the UE. And subsequently, the source MN indicates the changes to the target SNs and receives new delta configurations from the target SNs. The source MN may then be configured to compare the new delta configurations with the initial delta configurations that have been stored by the source MN. If the new delta configurations are identical to the initial delta configurations, the source MN may be configured to not send the RRC RECONFIGURATION message (or the like) to the UE. In other words, the source MN may be configured to skip updating the conditional configuration(s) of the target cell(s) given that it/they has/have not been changed.

Notably, as can be seen from the figures, the example embodiment as shown in FIG. 6 is more or less similar to that as shown in FIG. 5, except for the network elements being involved (i.e., source/target gNBs in CHO cases of FIG. 5 vs. source MN/target SN(s) in CP(A)C cases of FIG. 6) and corresponding the messaging/signaling exchanged between respective network elements.

To be more specific, as shown in FIG. 6, in step S601, the source MN sends the SN ADDITION REQUEST (or other similar, suitable messages) to (each of) the target SN(s) (numbered #1 to #N). As can be understood and appreciated by the skilled person, even though, for ease of illustration, two target SNs (numbered #1 and #N, respectively) are illustrated in the example of FIG. 6, any other suitable number of target SNs (even only one, in some possible cases) may be possible as well, depending on various implementations and/or requirements.

Subsequently, in steps S602 and S603, the target SNs may be configured to obtain (e.g., generate, determine, or by using any other suitable means) a respective (initial) delta of the RRC configuration for each of the target cells. As can be understood and appreciated by the skilled person, the delta configurations are generated based on the source and target cell configurations (see also the above illustration with reference to Tables 1 and 2).

In steps S604 and S605, the target SNs may acknowledge the SN addition requests with for example the SN ADDITION REQUEST ACK along with the delta configurations, which are sent back from the target SNs to the source MN.

In step S606, the source MN may be configured to store (e.g., in a suitable memory or the like) the delta configurations, which are received from the target SNs in steps S604 and S605.

Afterwards, in steps S607 and S608, the RRC reconfiguration with the delta configurations is sent from the source MN to the UE (step S507) and, in return, the UE sends the RRC reconfiguration complete back to the source MN (step S508).

As exemplified in steps S609 and S610, the user plane configuration may be updated (e.g., a PDU session is released or setup, or DRB to QoS flow mapping is updated, etc.), and possibly also the corresponding DRB configurations may be updated as well.

As a result, in step S611, the source MN sends a new set of SN ADDITION REQUESTs with the updated DRB configurations (or the like) to the respective target SNs.

Accordingly, the target SNs may accept or reject the changes to the DRB configurations (or the like). In case the changes would be accepted, the target SNs may update the user RRC configuration and obtain (e.g., generate) the corresponding new delta configurations in response to such updated user plane configurations (e.g., DRB configurations), as exemplified in steps S612 and S613.

In steps S614 and S615, the target SNs acknowledge the SN addition requests with respective SN ADDITION REQUEST ACKs (or the like), along with the new delta configurations, which are again sent back to the source gNB.

Therein, as exemplarily shown in step S616, the source MN may be configured to compare the received new set of the delta configurations with the already stored initial delta configurations.

If there would be a difference detected (e.g., for any of the pair of respective delta configurations before and after the user plane update) in step S616, the corresponding delta configuration(s) is/are sent by the source gNB to the UE, in order to update the RRC configurations inside the CP(A)C configuration in step S617. Correspondingly, the UE may acknowledge such re-configuration as exemplified in step S618. Notably, depending on various implementations and/or requirements, the source MN may be configured to prepare and transmit separate RRC reconfiguration messages (for each of the detected differences in the delta configurations), or one (concatenated) RRC reconfiguration message (e.g., having different delta configurations for different target cells as different IEs within the single RRC reconfiguration message).

On the other hand, the re-configuration message(s) may be skipped if in step S616 the respective delta configurations would be found to be identical.

It may be worthwhile to note that, as could also be understood and appreciated by the skilled person, the RRC (re) configurations may typically exist some differences in the cases of CHO and CP(A)C procedures. Specifically, in the case of CHO, the information about the DRB configuration may generally be included in the RRCReconfiguration, which is inside the HandoverCommand, which itself is in the Target NG-RAN node To Source NG-RAN node Transparent Container of the HANDOVER REQUEST ACKNOWLEDGE (ACK). On the other hand, in the case of CPC, the information about the DRB configuration may generally be included in the CG-Config, which is in the S-NG-RAN node to M-NG-RAN node Container of the S-NODE MODIFICATION REQUEST ACKNOWLEDGE (ACK).

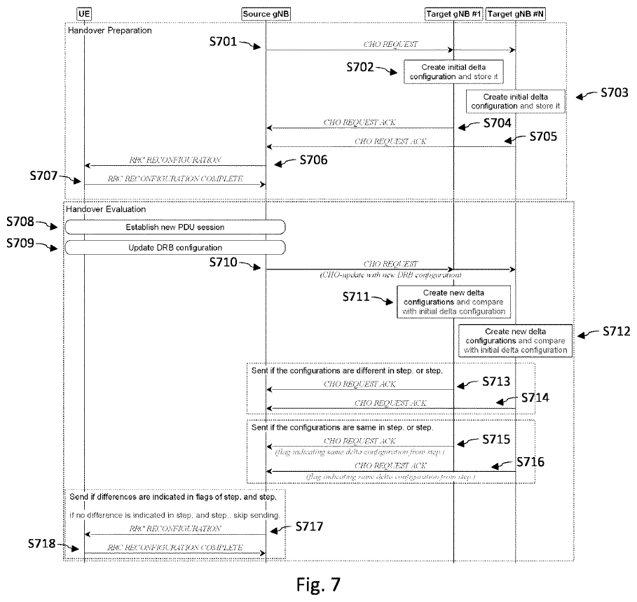

Moreover, FIG. 7 schematically illustrates another example of configuration update for CHO according to some example embodiments of the present disclosure. As noted above, identical or like reference numbers or messages (as well as the contents comprised therein) used in the figures of the present disclosure may, unless indicated otherwise, indicate identical or like elements messages (and the respective contents therein), such that repeated description thereof may be omitted for reasons of conciseness.

Generally speaking, in the example embodiment of FIG. 7, the target gNBs—instead of the source gNB as exemplarily illustrated with respect to FIG. 5—are configured to store the initial delta configurations of the candidate cells that the target gNB obtains (e.g., creates) after receiving the initial CHO REQUEST (or similar messages). After there is a change in user plane configuration, e.g., a PDU session is released or setup or, DRB to QoS flow mapping is updated, etc., the source network element may update the DRB configuration of the UE. Then, the source gNB indicates the changes to the target gNBs. Based on the modifications, the target gNBs generate new delta configurations and compare by themselves—instead of the source gNB as exemplarily illustrated with respect to FIG. 5—those configurations with the initial delta configurations (which have already been stored by the target gNB(s)). If those configurations are identical, the target gNBs do not send the new delta configuration(s) and may instead indicate the identical delta configurations in the CHO REQUEST ACK to the source gNB. Notably, as can be understood and appreciated by the skilled person, such indication of the delta configurations being identical (or in other words, the delta configuration has not been changed/updated) may be achieved by using any suitable (explicit) means, such as (but not to be understood as a limitation of any kind) a (Boolean) flag, a (binary or enumerated) value, a bitmap for each PCell (which itself may be contained in a flag or the like), or the like. In some possible (non-limiting) examples, it may also be possible to, e.g., by not sending (omitting) the CHO REQUEST ACK (or the like) to the source gNB or the like, implicitly convey the information indicating that the delta configurations before and after the user plane configuration are identical. Put differently, the omission or absence of a suitable message (or a part thereof, such as a suitable IE) may be used to implicitly indicate the identical delta configurations. In some possible implementations (e.g., only one RRC reconfiguration is to be exchanged between the source gNB and the UE regardless of the number of target gNBs), the source gNB may be configured to skip the processes of sending the RRC reconfiguration and receiving RRC reconfiguration complete message from the UE, if all the target gNBs indicate identical delta configurations. Correspondingly, in the case that a subset of the prepared target gNBs indicates non-identical delta configurations, the source gNB would send the RRC reconfiguration only for those which did not indicate identical delta configurations. On the other hand, in some other possible implementations (e.g., a respective RRC reconfiguration is to be exchanged between the source gNB and the UE for each target gNB), the source gNB may be configured to skip the processes of sending the RRC reconfiguration and receiving RRC reconfiguration complete message from the UE only for those that indicate identical delta configurations while still perform the usual RRC reconfiguration procedures for the other target gNBs that indicate non-identical delta configurations.

Now with reference to FIG. 7, as shown in step S701, the source gNB sends the CHO REQUEST (or other similar, suitable messages) to (each of) the target gNB(s) (numbered #1 to #N). As can be understood and appreciated by the skilled person, even though, for ease of illustration, two target gNBs (numbered #1 and #N, respectively) are illustrated in the example of FIG. 7, any other suitable number of target gNBs (even only one, in some possible cases) may be possible as well, depending on various implementations and/or requirements.

In the present example of FIG. 7 (in comparison with that of FIG. 5), instead of the source gNB being configured to store the (initial) delta configurations as shown in the example of FIG. 5, this time it is the target gNBs that is configured to generate and subsequently store the deltas of the RRC configurations for the target cells. Similar to the above, the delta configurations are generated based on the source and target cell configurations (as exemplarily shown in steps S702 and S703).

In steps S704 and S705, the target gNBs may acknowledge the CHO requests with for example the CHO REQUEST ACK along with the delta configurations, which are sent back from the target gNBs to the source gNB.

Subsequently in steps S706 and S707, the RRC reconfigurations with the delta configurations for CHO are sent from the source gNB to the UE (step S706) and, in return, the UE sends the RRC reconfiguration complete back to the source gNB (step S707).

As exemplified in steps S708 and S709, the user plane configuration may be updated (e.g., a PDU session is released or setup, or DRB to QoS flow mapping is updated, etc.), and possibly also the corresponding DRB configurations may be updated.

As a result, in step S710, the source gNB sends a new set of CHO REQUESTS with the updated DRB configurations (or the like) to the respective target gNBs.

Accordingly, the target gNBs may accept or reject the changes to the DRB configurations (or the like). In case the changes would be accepted, the target gNBs may update the user RRC configuration and obtain (e.g., generate) the corresponding new delta configurations in response to such updated user plane configurations (e.g., DRB configurations). Now, in the present example of FIG. 7, as exemplified in steps S711 and S712, it is now the target gNBs that are configured to compare the newly generated/created delta configurations with those that have already been stored in the target gNBs (as exemplified in steps S702 and S703) instead of the source gNB as shown in the example of FIG. 5.

As exemplarily shown in steps S713 and S714, if it is determined that the new delta configurations are different from the initial delta configurations (as compared in steps S711 and S712), the target gNBs acknowledge the CHO requests with respective CHO REQUEST ACKs (or the like), along with the new delta configurations, which are sent back to the source gNB.

On the other hand, as exemplarily shown in steps S715 and S716, if it is determined that the new delta configurations are identical to the initial delta configurations (as compared in steps S711 and S712), the target gNBs may be configured to convey this to the source gNB by using any suitable means as illustrated above. For instance, as an illustrative example (but not as a limitation of any kind), the target gNBs may be configured to transmit in the CHO REQUEST ACKs (or the like) (only) a respective flag that indicates that the configurations before and after the update are identical instead of the complete (full or delta) configurations. As can be understood and appreciated by the skilled person, such a flag may be implemented by using any suitable means, such as (reusing) an old parameter/IE or (introducing) a new parameter/IE. Of course, any other suitable implementations other than the flag, whether explicit or implicit, may be adopted as illustrated above already.

Accordingly, if a new configuration is received with the CHO REQUEST ACK, the source gNB sends the configurations to the UE with the RRC reconfiguration (step S717) and receives the corresponding RRC reconfiguration complete from the UE (step S718).

On the other hand, in the illustrative example of FIG. 7 (where a possible flag is used to convey the indication that the configurations before and after the update are identical), if there is a flag that indicates that the delta configurations are identical in the received CHO REQUEST ACK, the source gNB may be configured to not send (skip) the configuration towards the UE.

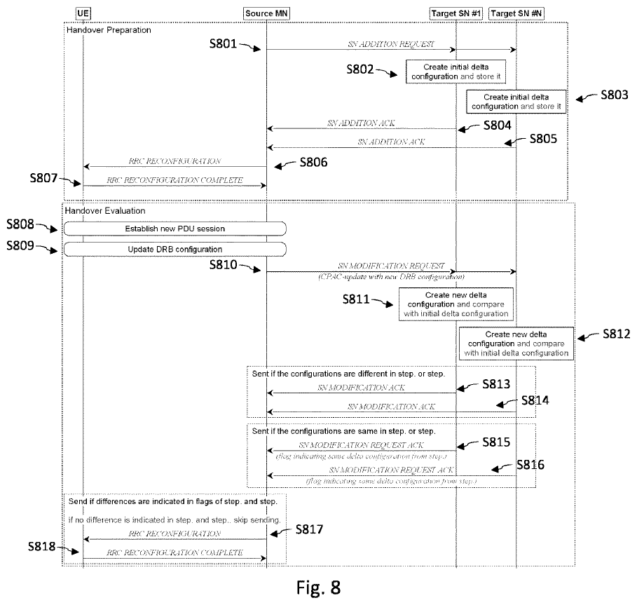

Finally, FIG. 8 schematically illustrates another example of configuration update for CPC/CPA according to some example embodiments of the present disclosure. As noted above, identical or like reference numbers or messages (as well as the contents comprised therein) used in the figures of the present disclosure may, unless indicated otherwise, indicate identical or like elements messages (and the respective contents therein), such that repeated description thereof may be omitted for reasons of conciseness.

Generally speaking, in the example of FIG. 8, it may be understood that, for the case of CP(A)C, the target SN(s) may—similar to the target gNB as described in the above FIG. 7 with respect to the case of CHO—be configured to store the initial delta configurations that are received with for example the SN ADDITION REQUEST ACK (or similar messages). After there is a change in the user plane configuration (e.g., a PDU session is released or setup, or DRB to QoS flow mapping is updated, etc.), the source MN may be configured to update the DRB configuration of the UE. And subsequently, the source MN indicates the changes to the target SNs. Based on the modifications, the target SNs may be configured to generate new delta configurations and compare those configurations with the already stored initial delta configurations. If those configurations are identical, the target SNs may be configured to indicate the identical delta configurations, rather than sending the configurations, for example with a flag or the like in the SN MODIFICATION REQUEST ACKs (or the like) to the source MN. As noted above, such indication of the delta configurations being identical (or in other words, the delta configuration has not been changed/updated) may be achieved by using any suitable (explicit) means, such as (but not to be understood as a limitation of any kind) a (Boolean) flag, a (binary or enumerated) value, a bitmap for each PSCell (which itself may be contained in a flag or the like), or the like. In some possible (non-limiting) examples, it may also be possible to, e.g., by not sending (omitting) the SN MODIFICATION REQUEST ACK to the source MN or the like, implicitly convey the information indicating that the delta configurations before and after the user plane configuration are identical. Put differently, the omission or absence of a suitable message (or a part thereof, such as a suitable IE) may be used to implicitly indicate the identical delta configurations. In some possible implementations (e.g., only one RRC reconfiguration is to be exchanged between the source MN and the UE regardless of the number of target SNs), the source MN may be configured to skip the processes of sending the RRC reconfiguration and receiving RRC reconfiguration complete message from the UE, if all the target SNs indicate identical delta configurations. Correspondingly, in the case that a subset of the prepared target SNs indicates non-identical delta configurations, the source MN might send the RRC reconfiguration only for those which did not indicate identical delta configurations. On the other hand, in some other possible implementations (e.g., a respective RRC reconfiguration is to be exchanged between the source MN and the UE for each target SN), the source MN may be configured to skip the processes of sending the RRC reconfiguration and receiving RRC reconfiguration complete message from the UE only for those that indicate identical delta configurations while still perform the usual RRC reconfiguration procedures for the other target SNs that indicate non-identical delta configurations.

It is also to be noted that, similar to the example embodiments as illustrated with respect to FIGS. 5 and 6, the example embodiment as shown in FIG. 8 is more or less similar to that as shown in FIG. 7, except for the network elements being involved (i.e., source/target gNBs in CHO cases of FIG. 7 vs. source MN/target SN(s) in CP(A)C cases of FIG. 8) and corresponding the messaging/signaling exchanged between respective network elements.

To be more specific, as shown in the illustrative (non-limiting) example of FIG. 8, in step S801, the source MN sends the SN ADDITION REQUEST (or other similar, suitable messages) to (each of) the target SN(s) (numbered #1 to #N). As can be understood and appreciated by the skilled person, even though, for ease of illustration, two target SNs (numbered #1 and #N, respectively) are illustrated in the example of FIG. 6, any other suitable number of target SNs (even only one, in some possible cases) may be possible as well, depending on various implementations and/or requirements.

In the present example of FIG. 8 (in comparison with that of FIG. 6), instead of the source MN being configured to store the (initial) delta configurations as shown in the example of FIG. 5, this time it is the target gNBs that is configured to generate and subsequently store the deltas of the RRC configurations for the target cells. Similar to above, the delta configurations are generated based on the source and target cell configurations (as exemplarily shown in steps S802 and S803).

In steps S804 and S805, the target SN may acknowledge the SN addition requests with for example the SN ADDITION REQUEST ACK along with the delta configurations, which are sent back from the target SNs to the source MN.

Subsequently in steps S806 and S807, the RRC reconfigurations with the delta configurations for CP(A)C are sent from the source MN to the UE (step S806) and, in return, the UE sends the RRC reconfiguration complete back to the source MN (step S807).

As exemplified in steps S808 and S809, the user plane configuration may be updated (e.g., a PDU session is released or setup, or DRB to QoS flow mapping is updated, etc.), and possibly also the corresponding DRB configurations may be updated.

As a result, in step S810, the source MN sends a new set of SN ADDITION REQUESTs with the updated DRB configurations (or the like) to the respective target SNs.

Accordingly, the target SNs may accept or reject the changes to the DRB configurations (or the like). In case the changes would be accepted, the target SNs may update the UE RRC configuration and obtain (e.g., generate) the corresponding new delta configurations in response to such updated user plane configurations (e.g., DRB configurations). Now, in the present example of FIG. 8, as exemplified in steps S811 and S812, it is now the target SNs that are configured to compare the newly generated/created delta configurations with those that have already been stored in the target SNs (as exemplified in steps S802 and S803) instead of the source MN as shown in the example of FIG. 6.

As exemplarily shown in steps S813 and S814, if it is determined that the new delta configurations are different from the initial delta configurations (as compared in steps S811 and S812), the target SNs acknowledge the SN addition requests with respective SN ADDITION REQUEST ACKs (or the like), which contain the new delta configurations.

On the other hand, as exemplarily shown in steps S815 and S816, if it is determined that the new delta configurations are identical to the initial delta configurations (as compared in steps S811 and S812), the target SNs may be configured to convey this to the source MN by using any suitable means as illustrated above. For instance, as an illustrative example (but not as a limitation of any kind), the target SNs may be configured to transmit in the SN ADDITION REQUEST ACK messages (or the like) (only) a respective flag which indicates that the configurations before and after the update are identical instead of the complete (full or delta) configurations. As can be understood and appreciated by the skilled person, such a flag may be implemented by using any suitable means, such as (reusing) an old parameter/IE or (introducing) a new parameter/IE. Of course, any other suitable implementations other than the flag, whether being an explicit indication or an implicit indication, may be adopted as illustrated above already.

Accordingly, if a new configuration is received with the SN ADDITION REQUEST ACK, the source MN sends the configurations to the UE with the RRC reconfiguration (step S817) and receives the corresponding RRC reconfiguration complete from the UE (step S818).

On the other hand, in the illustrative example of FIG. 8 (where a possible flag is used to convey the indication that the configurations before and after the update are identical), if there is a flag that indicates that the delta configurations are identical in the received SN ADDITION REQUEST ACK, the source MN may be configured to not send (skip) any configuration towards the UE.

It may be worthwhile to mention that, as can be understood and appreciated by the skilled person, the example embodiments as illustrated above with reference to the figures may be generally considered to relate to mobility procedures (when the UE is) in the RRC-connected state. In other words, it may be generally understood that the UE is already connected (RRC-connected) to a source/serving cell for example controlled by a source/serving network element/node; and that the UE has already been configured with an (initial) RRC configuration. Furthermore, the terms initial delta (RRC) configuration (obtained during the mobility preparation phase) and new/updated delta (RRC) configuration (obtained during the mobility evaluation phase) may have been used in the above-illustrated example embodiments. However, in some possible cases, they may be simply referred to as a first and second (or any other suitable numbering, or even any other suitable different naming) delta (RRC) configurations, respectively. In view thereof, in a broad sense, as can also be understood and appreciated by the skilled person, the expression initial or first (or the like) may be generally seen to refer to a current (presently applied) RRC configuration configured at the UE; while the expression new/updated or second (or the like) may be generally seen to refer a newly/recently generated RRC configuration that is to be applied at the UE. Therefore, it could also be envisaged that, in some possible cases, the first delta (RRC) configuration does not necessarily have to be always used to refer to the delta configuration that is obtained (e.g., generated) during the mobility preparation phase, but the first and second delta (RRC) configuration could both be obtained during the mobility evaluation phase (or the like).

To summarize the above, it is respectfully noted that the mechanisms/techniques as proposed in the present disclosure generally avoid unnecessarily reconfiguring the conditional configuration in case the new configuration is the same as the old configuration, thereby also reducing signaling overhead over the radio interface. Moreover, it is to be noted that the mechanisms/techniques as proposed in the present disclosure also do not require a complex coordination mechanism between the source and target network elements, thereby further improving the efficiency and flexibility of the overall system.

For the sake of completeness, it is noted that, in any of the example embodiments as described above with reference to the figures of the present disclosure, in case of a network element (e.g., a target gNB or a target SN) being associated with more than one cell, the delta configuration may be obtained on a per cell basis, as can be understood and appreciated by the skilled person.

Finally, it is nevertheless to be noted that, although in the above-illustrated example embodiments (with reference to the figures), the messages communicated/exchanged between the network components/elements may appear to have specific/explicit names, depending on various implementations (e.g., the underlining technologies), these messages may have different names and/or be communicated/exchanged in different forms/formats, as can be understood and appreciated by the skilled person.

According to some example embodiments, there are also provided corresponding methods suitable to be carried out by the apparatuses (network elements/components) as described above, such as the UE, the source and target network elements (e.g., gNB, MN, SN, etc.).

It should also be noted that the apparatus (or system) features described above correspond to respective method features that may however not be explicitly described, for reasons of conciseness. The disclosure of the present document is considered to extend also to such method features. In particular, the present disclosure is understood to relate to methods of operating the devices described above, and/or to providing and/or arranging respective elements of these devices.

Further, according to some further example embodiments, there is also provided a respective apparatus (e.g., implementing the UE, the source/target gNB, the MN, the SN, etc., as described above) that comprises at least one processing circuitry, and at least one memory for storing instructions to be executed by the processing circuitry, wherein the at least one memory and the instructions are configured to, with the at least one processing circuitry, cause the respective apparatus to at least perform the respective steps as described above.

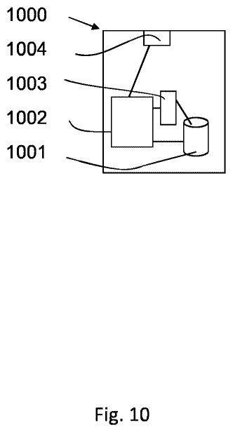

An illustrative (non-limiting) example for such an apparatus 1000 is schematically shown in FIG. 10. The apparatus 1000 may be implemented as any suitable network node/component/element for a communication system, for example to be coupled to and/or for controlling a station of an access system, such as a RAN node, e.g. a base station, eNB or gNB, a relay node or a core network node such as an MME or S-GW or P-GW, or a core network function such as AMF/SMF, a server or host, an MN or an SN, or in some possible implementations, a UE. Depending on various implementations, the method as described in the present disclosure may be implemented in a single apparatus or across more than one apparatus. The apparatus may be integrated with or external to a node or module of a core network, RAN, or the like. In particular, the apparatus 1000 may be arranged to provide control on communications in the service area of the system. The control apparatus 1000 may comprise at least one memory 1001, at least one data processing unit (or circuitry) 1002, 1003 and an input/output interface 1004. Via the interface 1004 the apparatus 1000 may be coupled to any other suitable component (e.g., a receiver and/or a transmitter) of the apparatus 1000, or to any other suitable other apparatus(es). In some possible examples, the receiver and/or the transmitter may be implemented as a radio front end or a remote radio head.

Yet in some other example embodiments, there is provided a respective apparatus (e.g., implementing the UE, the source/target gNB, the MN, the SN, etc., as described above) that comprises respective means configured to at least perform the respective steps as described above.

It is to be noted that examples of embodiments of the disclosure are applicable to various different network configurations. In other words, the examples shown in the above described figures, which are used as a basis for the above discussed examples, are only illustrative and do not limit the present disclosure in any way. That is, additional further existing and proposed new functionalities available in a corresponding operating environment may be used in connection with examples of embodiments of the disclosure based on the principles defined.

It should also be noted that the disclosed example embodiments can be implemented in many ways using hardware and/or software configurations. For example, the disclosed embodiments may be implemented using dedicated hardware and/or hardware in association with software executable thereon. The components and/or elements in the figures are examples only and do not limit the scope of use or functionality of any hardware, software in combination with hardware, firmware, embedded logic component, or a combination of two or more such components implementing particular embodiments of the present disclosure.

It should further be noted that the description and drawings merely illustrate the principles of the present disclosure. Those skilled in the art will be able to implement various arrangements that, although not explicitly described or shown herein, embody the principles of the present disclosure and are included within its spirit and scope. Furthermore, all examples and embodiment outlined in the present disclosure are principally intended expressly to be only for explanatory purposes to help the reader in understanding the principles of the proposed method. Furthermore, all statements herein providing principles, aspects, and embodiments of the present disclosure, as well as specific examples thereof, are intended to encompass equivalents thereof.

1.-24. (canceled)

25. A source network element configured for supporting a conditional mobility procedure involving at least one target network element and a user equipment, UE, served by the source network element, the source network element comprising:
at least one processor; and
at least one memory storing instructions that, when executed by the at least one processor, cause the source network element at least to:
obtain a first delta radio resource control, RRC, configuration that is indicative of a difference between an RRC configuration of the source network element and an RRC configuration of the target network element;
store the first delta RRC configuration;
obtain a second delta RRC configuration that is indicative of a difference between an RRC configuration of the source network element and an RRC configuration of the target network element after a user plane configuration of the UE is updated;
compare the obtained second delta RRC configuration with the stored first delta RRC configuration to determine whether the first and second delta RRC configurations are identical or not;
based on determining that the first and second delta RRC configurations are not identical: transmit an RRC reconfiguration message to the UE; and
based on determining that the first and second delta RRC configurations are identical: skip the transmission of the RRC reconfiguration message to the UE.

26. The source network element according to claim 25, wherein the source network element obtains the first delta RRC configuration by:
receiving, from the target network element, the first delta RRC configuration in response to a first request message indicative of the conditional mobility procedure sent to the target network element; and
wherein the source network element obtains the second delta RRC configuration by:
receiving, from the target network element, the second delta RRC configuration in response to a second request message indicative of the conditional mobility procedure sent to the target network element.

27. The source network element according to claim 25, wherein
when the conditional mobility procedure involves a conditional handover, CHO, procedure, the source network element is a gNB, and the first and second conditional mobility procedure requests are conditional handover requests; or
when the conditional mobility procedure involves a conditional PSCell change, CPC, procedure or a conditional PSCell addition, CPA, procedure, the source network element is a master node, MN, and the first and second conditional mobility procedure requests are SN addition requests.

28. A target network element configured for supporting a conditional mobility procedure involving a source network element serving a user equipment, UE, and the target network element, the target network element comprising:
at least one processor; and
at least one memory storing instructions that, when executed by the at least one processor, cause the target network element at least to:
obtain a first delta radio resource control, RRC, configuration that is indicative of a difference between an RRC configuration of the source network element and an RRC configuration of the target network element;
store the first delta RRC configuration;
obtain a second delta RRC configuration that is indicative of a difference between an RRC configuration of the source network element and an RRC configuration of the target network element after a user plane configuration of the UE is updated;
compare the obtained second delta RRC configuration with the stored first delta RRC configuration to determine whether the first and second delta RRC configurations are identical or not;
based on determining that the first and second delta RRC configurations are not identical:
transmit the second delta RRC configuration to the source network element, for enabling the source network element to transmit an RRC reconfiguration message to the UE; and
based on determining that the first and second delta RRC configurations are identical: transmit information indicative of the first and second delta RRC configurations being identical to the source network element, such that transmission of the RRC reconfiguration message from the source network element to the UE can be skipped.

29. The target network element according to claim 28, wherein the target network element obtains the first delta RRC configuration by:
generating, by the target network element, the first delta RRC configuration based on a received first request message indicative of the conditional mobility procedure; and
wherein the target network element obtains the second delta RRC configuration by: generating, by the target network element, the second delta RRC configuration based on a received second request message indicative of the conditional mobility procedure.

30. The target network element according to claim 28, wherein
when the conditional mobility procedure involves a conditional handover, CHO, procedure, the target network element is a gNB, and the first and second conditional mobility procedure requests are conditional handover requests; or
when the conditional mobility procedure involves a conditional PSCell change, CPC, procedure or a conditional PSCell addition, CPA, procedure, the target network element is a secondary node, SN, and the first and second conditional mobility procedure requests are SN addition requests.

31. A source network element configured for supporting a conditional mobility procedure involving at least one target network element and a user equipment, UE, served by the source network element, the source network element comprising:
at least one processor; and
at least one memory storing instructions that, when executed by the at least one processor, cause the source network element at least to:
transmit a first request message indicative of the conditional mobility procedure to the target network element;
receive a first delta RRC configuration from the target network element in response to the first conditional mobility procedure request;
based on the received first delta RRC configuration, transmit a first RRC reconfiguration message to the UE conveying the RRC configuration of the target network element for the conditional mobility procedure;
in response to updating a user plane configuration of the UE, send a second request message indicative of the conditional mobility procedure to the target network element;
when receiving a second delta RRC configuration from the target network element in response to the second conditional mobility procedure request:
transmit a second RRC reconfiguration message to the UE; and
when receiving information indicative of the delta RRC configuration having not been changed from the target network element in response to the second conditional mobility request: skip the transmission of the second RRC reconfiguration message to the UE.
